(19) United States
(12) Patent Application Publication
(10) Pub. No.: US 2018/0283861 A1
(43) Pub. Date: Oct. 4, 2018

(54) ALTITUDE MEASUREMENT SYSTEM AND ALTITUDE MEASUREMENT METHOD

(71) Applicant: National Institute of Advanced Industrial Science and Technology, Tokyo (JP)

(72) Inventors: Masakatsu Kourogi, Tsukuba-shi, Ibaraki (JP); Ryosuke Ichikari, Tsukuba-shi, Ibaraki (JP); Takeshi Kurata, Tsukuba-shi, Ibaraki (JP)

(21) Appl. No.: 15/742,583

(22) PCT Filed: Jul. 8, 2016
(86) PCT No.: PCT/JP2016/070282

§ 371 Date: May 25, 2018

(30) Foreign Application Priority Data
Jul. 9, 2015 (JP) 2015-138032

(51) Int. Cl. G01C 5/06

(52) U.S. Cl. CPC G01C 5/06; H04L 67/12

(57) ABSTRACT

An object of the present invention is to provide an altitude measurement system and an altitude measurement method capable of measuring an altitude of a moving body in a stand-alone mode. In order to achieve the present object, the invention provides an altitude measurement system having altitude measurement terminals M1 to Mn connected to the Internet connection and atmospheric-pressure trend management unit TM1 connected to the Internet connection, each of the altitude measurement terminals M1 to Mn including: an atmospheric-pressure measurement unit 201 that measures an atmospheric pressure; a same-floor-stay detection unit 202 and an in-area-stay detection unit 203 for detecting existence of the moving body at a predetermined altitude; and an atmospheric-pressure trend candidate value output unit 204 that outputs, to the atmospheric-pressure trend management unit TM1, atmospheric pressure data measured during a predetermined period by the atmospheric-pressure measurement unit 201 when the existence of the moving body exists at a predetermined altitude, and an atmospheric-pressure trend integration/generation unit 205 generating the reference atmospheric pressure data corresponding to the altitude by, as needed, calculating an average value among a plurality of pieces of the atmospheric pressure data supplied from the atmospheric-pressure trend candidate value output unit 204.

### CROSS-REFERENCE TO RELATED APPLICATIONS

This application is a National Stage application of International Patent Application No. PCT/JP2016/070282, filed on Jul. 8, 2016, which claims priority to Japanese Patent Application No. 2015-138032, filed on Jul. 9, 2015, each of which is hereby incorporated by reference in its entirety.

### TECHNICAL FIELD

The present invention relates to a system of and a method of measurement for an altitude of a moving body.

### BACKGROUND

In recent years, mobile terminals such as a smartphone having an atmospheric pressure sensor have been popularized to general consumers. A system has also appeared on the Internet, the system being intended to collect, on a collective intelligence basis, atmospheric pressure data that is obtained by usage of the mobile terminal by each of users who spreads all over the world so that the collected data is helpful for weather forecast.

And, as described in, for example, Japanese Patent Application Laid-Open Publication No. H11-347021 and Japanese Patent Application Laid-Open Publication No. 2015-29884, many techniques for estimating displacement of the mobile terminal user in an altitude direction, that is, for estimating change in a stay floor of the user have been developed.

Here, in the present techniques, when the user stays on the same altitude (floor), it is required to distinguish atmospheric pressure variation caused in entire area by change in weather or others and atmospheric pressure variation caused by change in the altitude on which the user stays.

In consideration of this issue, in order to improve accuracy of the estimation, Japanese Patent Application Laid-Open Publication No. 2011-117818 and “Location Estimation using Smartphone's Atmospheric Pressure Sensor and Weather Information”, Multimedia, Distributed, Cooperative and Mobile Symposium (DICOMO2013), Namiki et al., July 2013, pp. 1133 to 1139 propose a technique for obtaining the displacement in the altitude direction by providing an atmospheric pressure sensor at an altitude to be a reference in an area and calculating atmospheric pressure change caused by change in an altitude of a user after removing environmental-derived atmospheric pressure change observed by the atmospheric pressure sensor.

### SUMMARY

However, in the technique describe in the Japanese Patent Application Laid-Open Publication No. 2011-117818, it is required to place the atmospheric pressure sensor to be a reference for all areas and every building having a possibility of the user stay, and therefore, the technique has a problem of difficulty in wide application to society from a viewpoint of a cost.

The present invention has been made for solving such problems, and an object of the present invention is to provide an altitude measurement system and an altitude measurement method capable of measuring an altitude of a moving body in a stand-alone mode even when an atmospheric pressure sensor to be a reference as described above is not provided for every area and every building.

In order to solve the above-described problems, the present invention provides an altitude measurement system having an altitude measurement terminal connected to the Internet connection and data management means connected to the Internet connection, the altitude measurement terminal including: atmospheric pressure measurement means measuring an atmospheric pressure; detection means detecting existence of a moving body at a predetermined altitude; and atmospheric-pressure data output means outputting, to the data management means, atmospheric pressure data measured during a predetermined period by the atmospheric pressure measurement means when it is detected that the moving body exists at the altitude by the detection means, and the data management means generating reference atmospheric pressure data corresponding to the altitude by, as needed, calculating an average value among a plurality of pieces of the atmospheric pressure data supplied from the atmospheric-pressure data output means.

In order to solve the above-described problems, the present invention provides an altitude measurement system having an altitude measurement terminal connected to the Internet connection and data management means connected to the Internet connection, the altitude measurement terminal including: atmospheric pressure measurement means measuring an atmospheric pressure; floor movement detection means detecting movement of a moving body from a floor to a floor; and atmospheric-pressure-difference data output means outputting, to the data management means, data indicating an atmospheric pressure difference between the floors before and after the movement measured by the atmospheric pressure measurement means when the movement of the moving body from the floor to the floor is detected by the floor movement detection means, and the data management means generating reference atmospheric pressure difference data corresponding to the movement from the floor to the floor by, as needed, calculating an average value among pieces of data indicating a plurality of atmospheric pressure differences supplied from the atmospheric-pressure-difference data output means.

In order to solve the above-described problems, the present invention provides an altitude measurement method measuring an altitude of a moving body by using an altitude measurement terminal connected to the Internet connection and data management means connected to the Internet connection, the method including: a first step of outputting, to the data management means, atmospheric pressure data measured during a predetermined period by the altitude measurement terminal when it is detected that the moving body exists at a predetermined altitude by the altitude measurement terminal; and a second step of generating reference atmospheric pressure data corresponding to the altitude by, as needed, calculating an average value among a plurality of pieces of the atmospheric pressure data supplied to the data management means.

In order to solve the above-described problems, the present invention provides an altitude measurement method measuring an altitude of a moving body by using an altitude measurement terminal connected to the Internet connection and data management means connected to the Internet connection, the method including: a first step of measuring an atmospheric pressure by the altitude measurement terminal; a second step of detecting movement of the moving body from a floor to a floor; a third step of outputting, to the data management means, data indicating an atmospheric pressure difference between the floors before and after the movement measured in the first step when the movement is detected in the second step; and a fourth step of generating reference atmospheric pressure difference data corresponding to the movement from the floor to the floor by, as needed, calculating an average value among pieces of data supplied to the data management means.

According to the present invention, an altitude measurement system and an altitude measurement method capable of measuring an altitude of a moving body in a stand-alone mode can be provided.

### BRIEF DESCRIPTIONS OF THE DRAWINGS

FIG. 1 is an entire configuration diagram illustrating a configuration of an altitude measurement system according to the present invention;

FIG. 2 is a graph for explaining an operation of the altitude measurement system illustrated in FIG. 1;

FIG. 3 is a configuration diagram illustrating a first embodiment of the altitude measurement system illustrated in FIG. 1;

FIG. 4 is a flowchart illustrating a first operation performed by the altitude measurement system illustrated in FIG. 3;

FIG. 5 is a flowchart for explaining an operation of a step S1 illustrated in FIG. 4;

FIG. 6 is a flowchart for explaining an operation of a step S2 illustrated in FIG. 4;

FIG. 7 is a first graph for explaining the operation illustrated in FIG. 6;

FIG. 8 is a second graph for explaining the operation illustrated in FIG. 6;

FIG. 9 is a third graph for explaining the operation illustrated in FIG. 6;

FIG. 10 is a flowchart illustrating a second operation performed by the altitude measurement system illustrated in FIG. 3;

FIG. 11 is a configuration diagram illustrating a second embodiment of the altitude measurement system illustrated in FIG. 1; and

FIG. 12 is a flowchart illustrating an operation of the altitude measurement system illustrated in FIG. 11.

### DETAILED DESCRIPTION

Hereinafter, embodiments of the present invention will be described in detail with reference to the accompanying drawings. In the drawings, note that the same reference symbols indicate the same or corresponding portions.

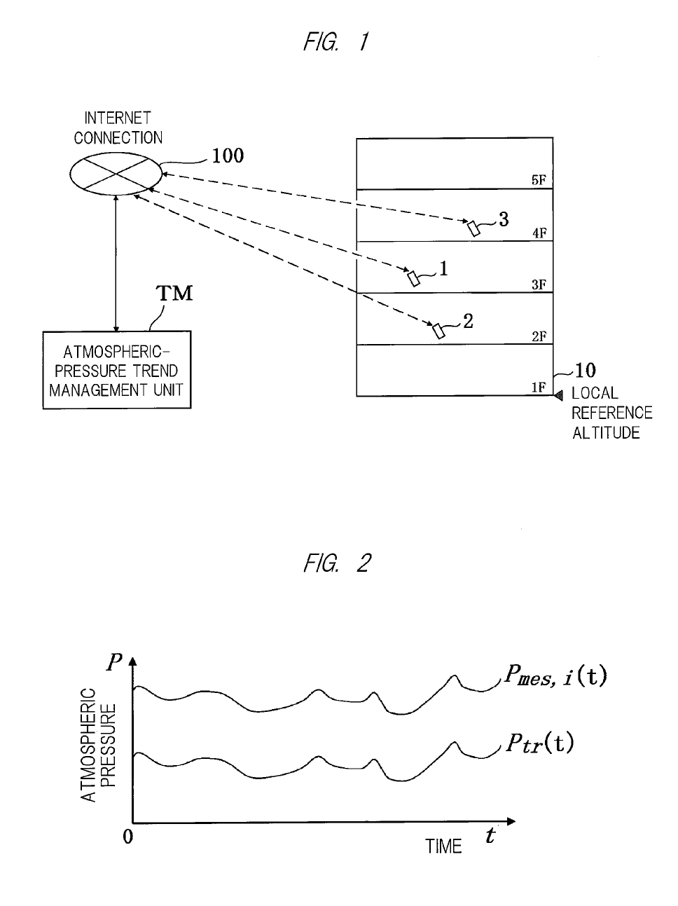

FIG. 1 is an entire configuration diagram illustrating a configuration of an altitude measurement system according to an embodiment of the present invention. As illustrated in FIG. 1, the altitude measurement system according to the embodiment of the present invention has altitude measurement terminals 1 to 3 connected to the Internet connection 100 and an atmospheric-pressure trend management unit TM connected to the Internet connection 100. Note that a reference symbol “1F” in FIG. 1 means a first floor of a building 10, and reference symbols “2F” and subsequent others have similar means.

Here, the altitude measurement terminals 1 to 3 are measurement devices such as a smartphone, a watch-type device, and mobile measurement equipment that are put on or held by a moving body such as a human, a cart, and a vehicle. The atmospheric-pressure trend management unit TM accumulates and manages atmospheric-pressure trend data sampled by the altitude measurement terminals 1 to 3 for each height (floor) from a local reference altitude when the altitude measurement terminals 1 to 3 exist on a plurality of floors whose altitudes are different from one another in the building 10 or others.

Note that the atmospheric-pressure trend data means atmospheric pressure data that is obtained during a predetermined period as illustrated in FIG. 2, and the atmospheric-pressure trend management unit TM generates reference atmospheric-pressure trend data Pₜᵣ(t) by accumulating and integrating atmospheric-pressure trend data P_{mes,i}(t) measured by i-th altitude measurement terminal as described later. The present altitude measurement system will be explained in detail below.

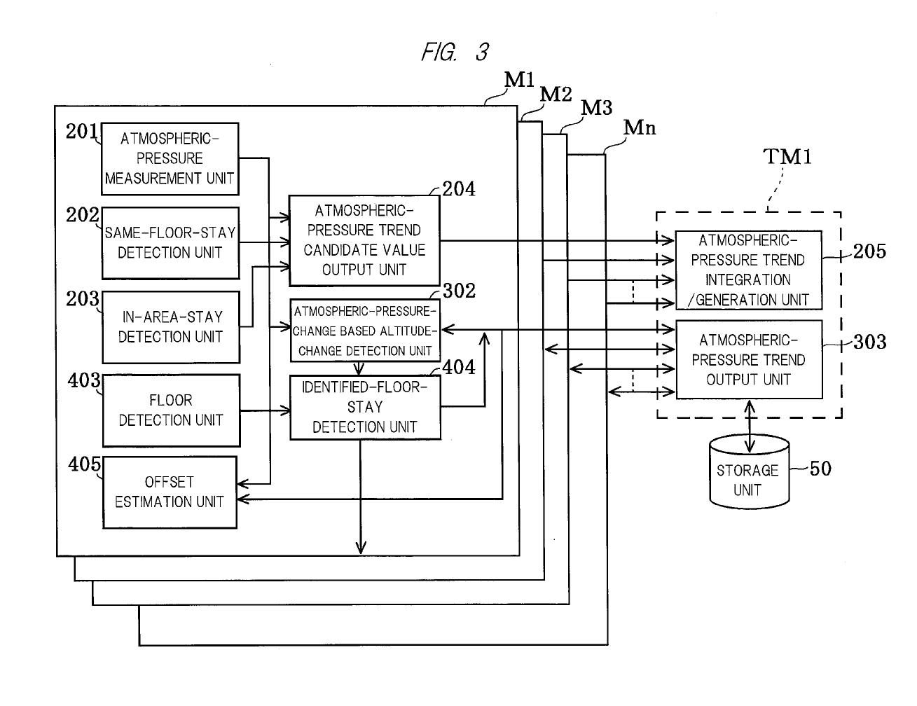

FIG. 3 is a configuration diagram illustrating a first embodiment of the altitude measurement system illustrated in FIG. 1. As illustrated in FIG. 3, the altitude measurement terminal M1 according to the present embodiment includes an atmospheric-pressure measurement unit 201, a same-floor-stay detection unit 202, an in-area-stay detection unit 203, an atmospheric-pressure trend candidate value output unit 204, an atmospheric-pressure-change based altitude-change detection unit 302, a floor detection unit 403, an identified-floor-stay detection unit 404, and an offset estimation unit 405. Note that each of altitude measurement terminals M2 to Mn (“n” is a natural number indicating the number of altitude measurement terminals) has the same configuration as that of the altitude measurement terminal M1.

And, the atmospheric-pressure trend management unit TM1 includes an atmospheric-pressure trend integration/generation unit 205 and an atmospheric-pressure trend output unit 303.

Here, the atmospheric-pressure trend candidate value output unit 204 is connected to the atmospheric-pressure measurement unit 201, the same-floor-stay detection unit 202 and the in-area-stay detection unit 203, and the atmospheric-pressure-change based altitude change detection unit 302 is connected to the atmospheric-pressure measurement unit 201. And, the identified-floor-stay detection unit 404 is connected to the atmospheric-pressure-change based altitude change detection unit 302 and the floor detection unit 403. And, the offset estimation unit 405 is connected to the atmospheric-pressure measurement unit 201 and the atmospheric-pressure trend output unit 303.

And, the atmospheric-pressure trend integration/generation unit 205 is connected to the atmospheric-pressure trend candidate value output unit 204, and the atmospheric-pressure trend output unit 303 is connected to the atmospheric-pressure-change based altitude change detection unit 302.

Further, the atmospheric-pressure trend management unit TM1 is connected to a storage unit 50.

In the above description, the atmospheric-pressure measurement unit 201 can be put on or held by the moving body, is configured of an apparatus or a device that can output the data indicating the measured atmospheric pressure, and corresponds to an atmospheric pressure sensor embedded in portable equipment such as a smartphone held by a human.

And, the same-floor-stay detection unit 202 detects and notifies that the moving body continues to stay on the same floor. Specifically, this unit is configured of, for example, a device detecting and displaying an outgoing signal, an access coverage of which from a tag inside a building or others is limited within the same floor, or a device detecting that the moving body continues to stay on the same floor by detecting movement of the moving body by using a motion sensor configured of combination of an acceleration sensor, an angular rate sensor, and others.

And, the in-area-stay detection unit 203 detects that the moving body exists in an applicable region (target area) of the present altitude measurement system. Specifically, this unit is configured of, for example, a device detecting existence of the present altitude measurement terminals M1 to Mn within the target area by detecting a unique ID for the tag or a wireless LAN (Local Area Network) base station.

And, only when it is detected that the moving body exists within the target area and continues to stay on the same floor by the in-area-stay detection unit 203 and the same-floor-stay detection unit 202, the atmospheric-pressure trend candidate value output unit 204 outputs the atmospheric-pressure trend data obtained by the measurement in the atmospheric-pressure measurement unit 201, as an atmospheric-pressure trend candidate value.

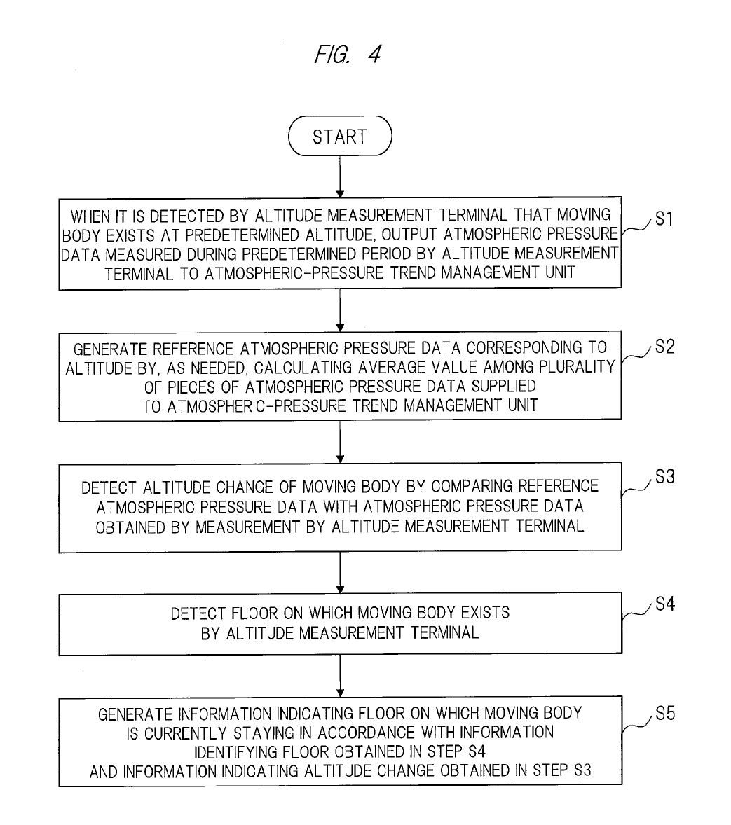

Operations of the altitude measurement system having the configuration as described above will be explained in detail below. FIG. 4 is a flowchart illustrating a first operation performed by the altitude measurement system illustrated in FIG. 3.

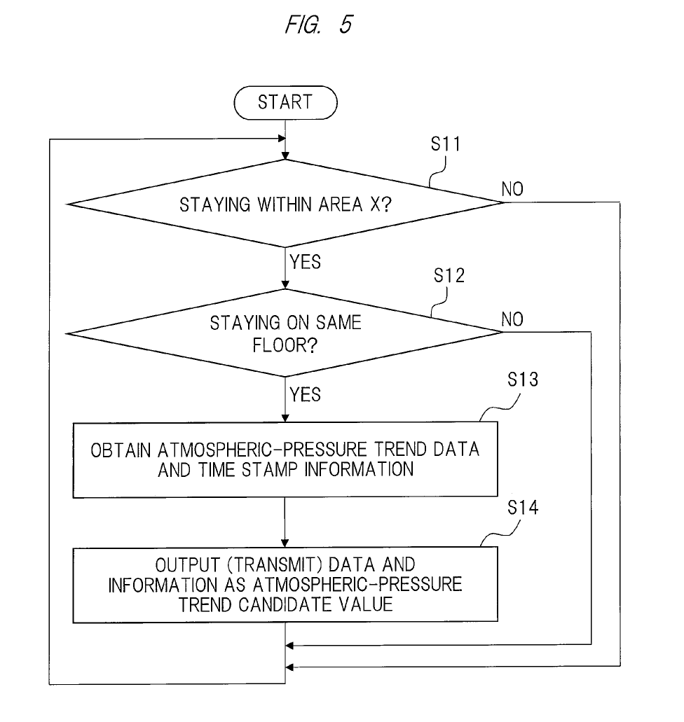

As illustrated in FIG. 4, in the step S1, when it is detected that the moving body exists at a predetermined altitude such as on a certain floor in an existing building 10 or others by the in-area-stay detection unit 203 and the same-floor-stay detection unit 202 included in the altitude measurement terminals M1 to Mn, the atmospheric-pressure trend candidate value output unit 204 outputs the atmospheric-pressure trend data that is measured during a predetermined period by the atmospheric-pressure measurement unit 201, to the atmospheric-pressure trend integration/generation unit 205. The operation in the present step S1 will be explained in detail below with reference to FIG. 5.

As illustrated in FIG. 5, in a step S11, the in-area-stay detection unit 203 determines whether or not each of the present altitude measurement terminals M1 to Mn, that is, the moving body stays within an area “X”. Note that “X” means an optional region identified by area information that is previously obtained.

And, if the in-area-stay detection unit 203 determines that the moving body stays within the area “X”, the operation proceeds to a step S12. In the step S12, the same-floor-stay detection unit 202 determines whether or not each of the present altitude measurement terminals M1 to Mn, that is, the moving body stays on the same floor. If it determines that the moving body stays on the same floor, the operation proceeds to a step S13. If it determines that the moving body does not stay on the same floor, the operation returns to the step S11.

In the step S13, the atmospheric-pressure measurement unit 201 obtains the above-described atmospheric-pressure trend data and time stamp information indicating an observation period of this data.

And, in the step S14, to the atmospheric-pressure trend integration/generation unit 205, the atmospheric-pressure trend candidate value output unit 204 outputs (transmits) the atmospheric-pressure trend data and the time stamp information obtained by the atmospheric-pressure measurement unit 201 in the step S13, as an atmospheric-pressure trend candidate value.

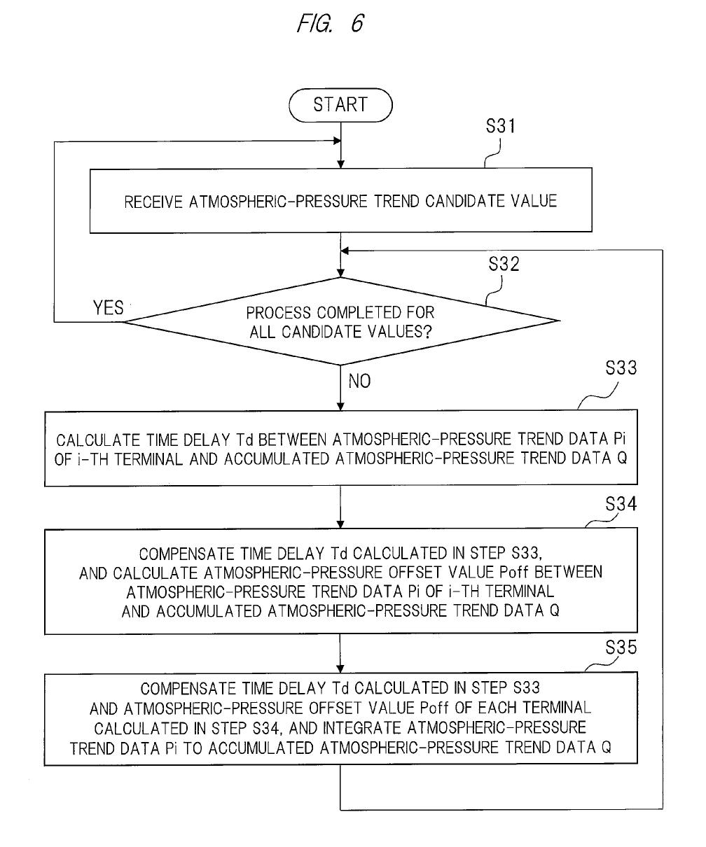

Next, in the step S2 illustrated in FIG. 4, the atmospheric-pressure trend integration/generation unit 205 generates the reference atmospheric pressure data corresponding to the altitude by, as needed, calculating the average value among the plurality of pieces of the atmospheric-pressure trend data supplied from the atmospheric-pressure trend candidate value output unit 204, and an operation in this step will be explained in detail below with respect to FIGS. 6 to 9.

As illustrated in FIG. 6, in the step S31, the atmospheric-pressure trend integration/generation unit 205 receives a plurality of the atmospheric-pressure trend candidate values supplied from the atmospheric-pressure trend candidate value output unit 204.

And, in the step S32, the atmospheric-pressure trend integration/generation unit 205 determines whether or not the following processes from a step S33 to a step S35 have been completed for all the atmospheric-pressure trend candidate values received in the step S31. If it determines that the processes have been completed, the operation returns to the step S31. If it determines that the processes have not been completed, the operation proceeds to the step S33.

In the step S33, the atmospheric-pressure trend integration/generation unit 205 calculates time delay “Td” as illustrated in FIG. 7 between atmospheric-pressure trend data “Pi” output from the i-th altitude measurement terminal and accumulated atmospheric-pressure trend data “Q” generated by the integration of a plurality of pieces of the atmospheric-pressure trend data. Here, the accumulated atmospheric-pressure trend data Q is generated by calculating an average value at each period of time for the plurality of pieces of the atmospheric-pressure trend data Pi as targets to which a later-described compensation process has been performed.

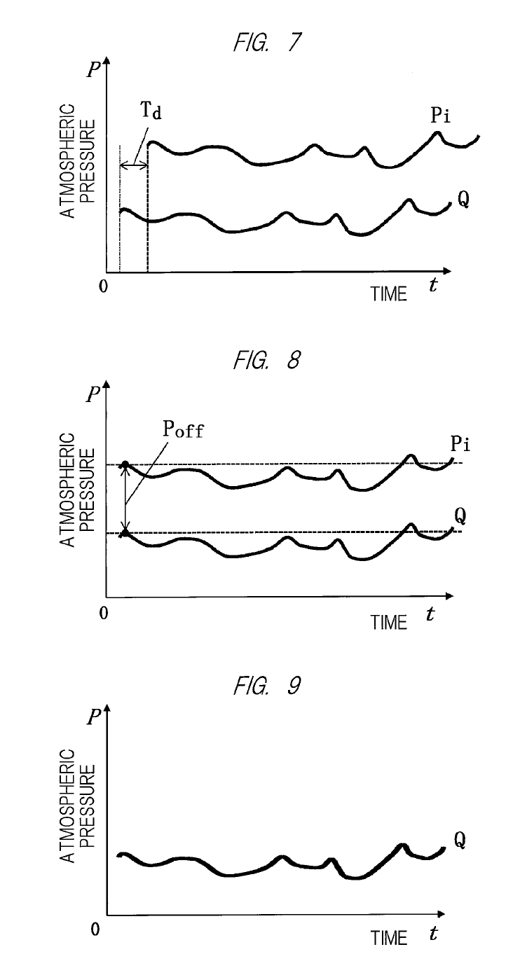

Next, in the step S34, as illustrated in FIG. 8, the atmospheric-pressure trend integration/generation unit 205 compensates the time delay Td that has been calculated for the atmospheric-pressure trend data Pi as the target in the step S33, and calculates an atmospheric-pressure offset value P_{off} between the atmospheric-pressure trend data and the accumulated atmospheric-pressure trend data Q.

And, in the step S35, the atmospheric-pressure trend integration/generation unit 205 compensates the time delay Td of the atmospheric-pressure trend data Pi calculated in the step S33 and the atmospheric-pressure offset value P_{off} of the same that is calculated in the step S34 and that is different for each altitude measurement terminal, and then, integrates the compensated atmospheric-pressure trend data Pi to the accumulated atmospheric-pressure trend data Q illustrated in FIG. 9, and the operation returns to the step S32. Note that the atmospheric-pressure trend integration/generation unit 205 stores the integrated accumulated atmospheric-pressure trend data Q into the storage unit 50.

Next, in the step S3 as illustrated in FIG. 4, the atmospheric-pressure-change based altitude change detection unit 302 detects the altitude change of the moving body by comparing the atmospheric-pressure trend data Pi that is obtained by the measurement by the atmospheric-pressure measurement unit 201 with the accumulated atmospheric-pressure trend data Q that is read and output from the storage unit 50 by the atmospheric-pressure trend output unit 303. Specifically, the atmospheric-pressure-change based altitude change detection unit 302 identifies the altitude change by, as needed, monitoring whether or not the atmospheric-pressure trend data Pi matches the accumulated atmospheric-pressure trend data Q and detecting a period of time at which the difference therebetween is made.

And, in the step S4, the floor detection unit 403 detects the floor on which the moving body exists. Specifically, note that the floor on which the moving body exists is detected by, for example, reception of an outgoing signal from a tag set inside a building or others by the floor detection unit 403.

Further, in the step S5, the identified-floor-stay detection unit 404 generates information indicating the floor on which the moving body is currently staying in accordance with the information identifying the floor that is supplied from the floor detection unit 403 and that is detected in the step S4 and the information indicating the altitude change that is supplied from the atmospheric-pressure-change based altitude change detection unit 302 and that is obtained in the step S3.

In the above description, according to the first operation performed by the altitude measurement system illustrated in FIG. 3, once the floor on which the moving body exists is detected by the floor detection unit 403 included in each of the altitude measurement terminals M1 to Mn, a stay floor after the movement of the moving body from the floor to the floor after the detection can be determined in a stand-alone mode by only the altitude measurement system itself.

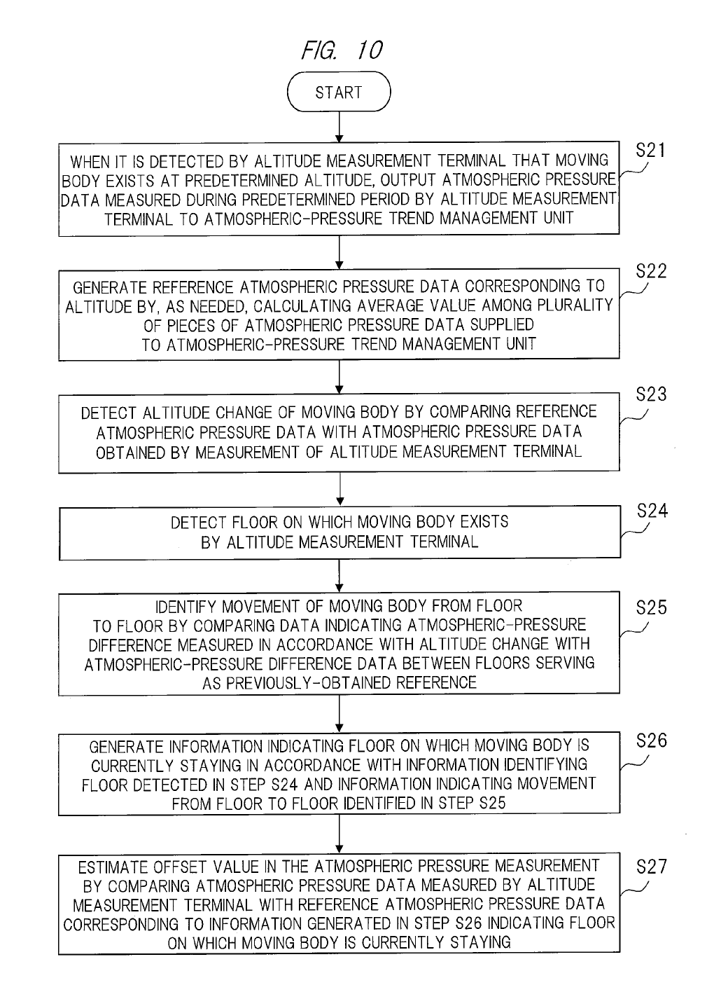

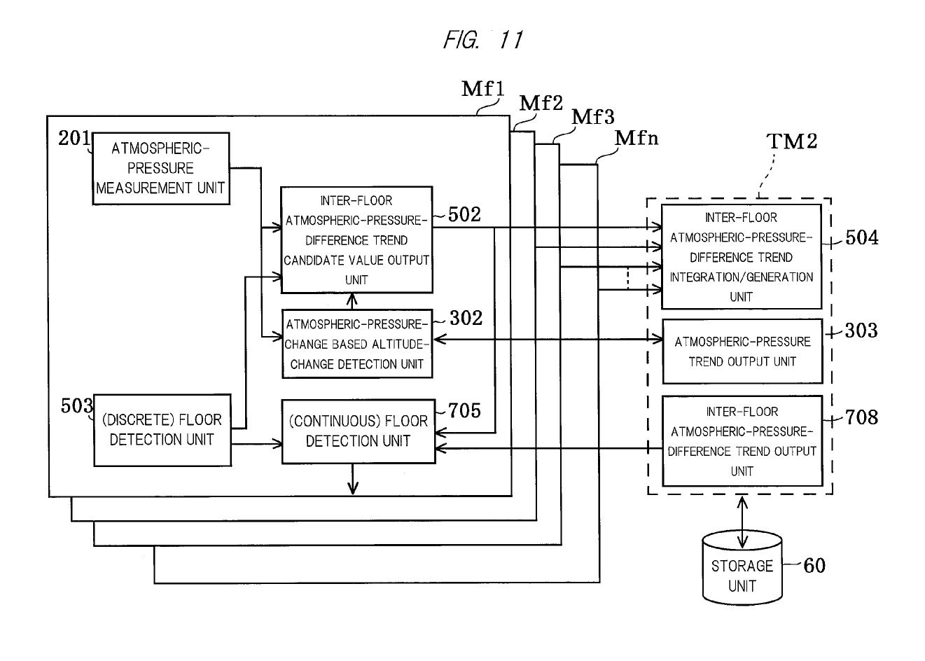

FIG. 10 is a flowchart illustrating a second operation performed by the altitude measurement system illustrated in FIG. 3. Note that the steps S21 to S24 illustrated in FIG. 10 are the same as the steps S1 to S4 illustrated in FIG. 4, and therefore, the description thereof is omitted.

Here, in the second operation, the atmospheric-pressure trend integration/generation unit 205 generates the accumulated atmospheric-pressure-difference trend data indicating a reference of the atmospheric pressure difference between the floors by calculating difference in the accumulated atmospheric-pressure trend data generated for each floor.

As illustrated in FIG. 10, in a step S25, the atmospheric-pressure-change based altitude change detection unit 302 identifies the movement of the moving body from the floor to the floor by comparing the accumulated atmospheric-pressure-difference trend data with change (difference) in the atmospheric-pressure trend data that is caused by the altitude change and that is measured by the atmospheric-pressure measurement unit 201.

And, in a step S26, the identified-floor-stay detection unit 404 generates information indicating the floor on which the moving body is currently staying, in accordance with the information identifying the floor that is detected in the step S24 and the information indicating the movement from the floor to the floor that is identified in the step S25.

Next, in a step S27, the identified-floor-stay detection unit 404 supplies the information indicating the floor on which the moving body is currently staying that is generated in the step S26, to the atmospheric-pressure trend output unit 303. In response to this, the atmospheric-pressure trend output unit 303 reads the accumulated atmospheric-pressure trend data corresponding to this floor, from the storage unit 50. And, the offset estimation unit 405 estimates an offset value for each of the altitude measurement terminals M1 to Mn in the atmospheric pressure measurement by the atmospheric-pressure measurement unit 201 by comparing the atmospheric-pressure trend data obtained by the measurement in the atmospheric-pressure measurement unit 201 with the accumulated atmospheric-pressure trend data that is read as described above.

According to the second operation of the altitude measurement system illustrated in FIG. 3 as described above, the offset value in the atmospheric pressure measurement that is different for each of the altitude measurement terminals M1 to Mn can be estimated in a stand-alone mode by only the present altitude measurement system itself.

FIG. 11 is a configuration diagram illustrating a second embodiment of the altitude measurement system according to the present invention. As illustrated in FIG. 11, the altitude measurement system Mf1 according to the present embodiment includes the atmospheric-pressure measurement unit 201, the atmospheric-pressure-change based altitude change detection unit 302, an inter-floor atmospheric-pressure-difference trend candidate value output unit 502, and floor detection units 503 and 705. Note that each of the altitude measurement terminals Mf2 to Mfn (“n” is a natural number indicating the number of altitude measurement terminals) illustrated in FIG. 11 has the same configuration as that of the altitude measurement terminal Mf1.

And, an atmospheric-pressure trend management unit TM2 includes the atmospheric-pressure trend output unit 303, an inter-floor atmospheric-pressure-difference trend integration/generation unit 504 and an inter-floor atmospheric-pressure-difference trend output unit 708.

Here, the inter-floor atmospheric-pressure-difference trend candidate value output unit 502 is connected to the atmospheric-pressure measurement unit 201, the atmospheric-pressure-change based altitude change detection unit 302, the floor detection unit 503 and the inter-floor atmospheric-pressure-difference trend integration/generation unit 504. The atmospheric-pressure-change based altitude change detection unit 302 is further connected to the atmospheric-pressure measurement unit 201 and the atmospheric-pressure trend output unit 303. And, the floor detection unit 503 is further connected to a floor detection unit 705, and the floor detection unit 705 is connected to the inter-floor atmospheric-pressure-difference trend candidate value output unit 502 and an inter-floor atmospheric-pressure-difference trend output unit 708.

And, the atmospheric-pressure trend management unit TM2 is connected to a storage unit 60.

In the altitude measurement system according to the second embodiment, it is assumed that the accumulated atmospheric-pressure trend data stored in the storage unit 50 illustrated in FIG. 3 is stored in the storage unit 60. However, even if the data is not stored therein, the altitude measurement system according to the second embodiment can be achieved by also providing the function of the altitude measurement system according to the first embodiment.

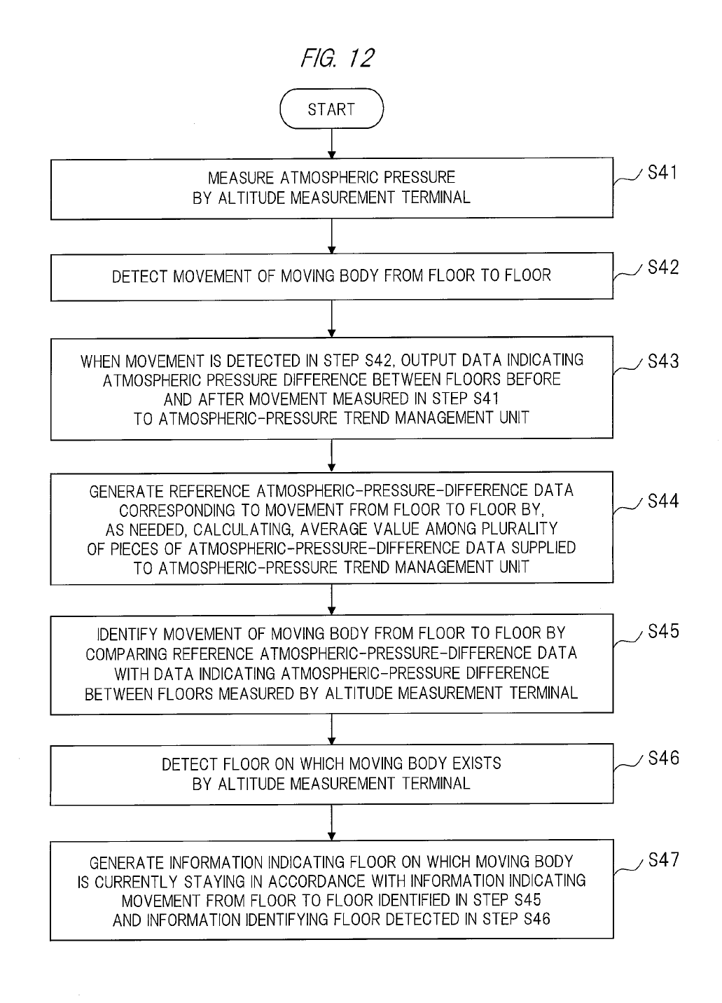

An operation of the altitude measurement system illustrated in FIG. 11 will be explained below with reference to FIG. 12.

First, in a step S41, the atmospheric-pressure measurement unit 201 measures an atmospheric pressure, and obtains atmospheric-pressure trend data.

Next, in a step S42, the atmospheric-pressure-change based altitude change detection unit 302 detects the movement of the moving body from the floor to the floor. Here, the present detection is executed by the same method as the altitude change detecting method explained in the altitude measurement system according to the first embodiment. That is, the atmospheric-pressure-change based altitude change detection unit 302 compares the atmospheric-pressure trend data supplied from the atmospheric-pressure measurement unit 201 with the accumulated atmospheric-pressure trend data read from the storage unit 60 via the atmospheric-pressure trend output unit 303, and detects the altitude change (the movement from the floor to the floor) by monitoring whether the difference therebetween is made or not. This is because the difference is made when the moving body moves from the floor to the floor to change the altitude of each of the altitude measurement terminals Mf1 to Mfn.

Next, in a step S43, if the movement has been detected in the step S42, the inter-floor atmospheric-pressure-difference trend candidate value output unit 502 calculates the difference in the atmospheric-pressure trend data measured in the step S41 before and after the movement, and outputs the calculated data as the atmospheric-pressure-difference trend data to the inter-floor atmospheric-pressure-difference trend integration/generation unit 504 of the atmospheric-pressure trend management unit TM2, the atmospheric-pressure-difference trend data indicating the difference in the atmospheric pressure between the floors that is made before and after the movement.

And, in a step S44, the inter-floor atmospheric-pressure-difference trend integration/generation unit 504 generates the accumulated atmospheric-pressure-difference trend data as the reference atmospheric-pressure-difference data corresponding to the movement from the floor to the floor by, as needed, calculating an average value among a plurality of pieces of the atmospheric-pressure-difference trend data that are supplied. Note that the generation of the accumulated atmospheric-pressure-difference trend data by the inter-floor atmospheric-pressure-difference trend integration/generation unit 504 is executed by using the same method as that in the integration of the atmospheric-pressure trend data performed by the atmospheric-pressure trend integration/generation unit 205 illustrated in FIG. 3.

Next, in a step S45, the floor detection unit 705 identifies the movement of the moving body from the floor to the floor by comparing the atmospheric-pressure-difference trend data supplied from the inter-floor atmospheric-pressure-difference trend candidate value output unit 502 with the accumulated atmospheric-pressure-difference trend data read from the storage unit 60 via the inter-floor atmospheric-pressure-difference trend output unit 708.

And, in a step S46, the floor detection unit 503 detects the floor on which the moving body exists. Note that this detection is executed by using the same method as the detection method performed by the floor detection unit 403 illustrated in FIG. 3 so that the floor on which the moving body exists is discretely detected, that is, the detection is physically executed to only the floor provided with the tag or others, thus, is temporally discontinuously executed.

And, in a step S47, the floor detection unit 705 generates information indicating the floor on which the moving body is currently staying, in accordance with the information indicating the movement from the floor to the floor that has been identified in the step S45 and the information identifying the floor that has been detected by the floor detection unit 503 in the step S46. By the generation of this information, the floor detection unit 705 continuously detects the floor on which the moving body exists, that is, the detection is not physically limited to the floor provided with the tag or others, thus, is temporally continuously executed.

In the altitude measurement system according to the second embodiment of the present invention as described above, as similar to the altitude measurement system according to the first embodiment, once the floor on which the moving body exists is detected by the floor detection unit 503 included in the altitude measurement terminals Mf1 to Mfn, the stay floor after the movement in the case of the movement of the moving body from the floor to the floor after the detection can be continuously determined in a stand-alone mode by only the altitude measurement system itself.

1 to 3, M1 to Mn, and Mf1 to Mfn altitude measurement terminal, 50, 60 storage unit, 100 Internet connection, 201, 501 atmospheric-pressure measurement unit, 202 same-floor-stay detection unit, 203 in-area-stay detection unit, 204 atmospheric-pressure trend candidate value output unit, 205 atmospheric-pressure trend integration/generation unit, 302 atmospheric-pressure-change based altitude-change detection unit, 303 atmospheric-pressure trend output unit, 403, 503, 705 floor detection unit, 404 identified-floor-stay detection unit, 405 offset estimation unit, 502 inter-floor atmospheric-pressure-difference candidate value output unit, 504 inter-floor atmospheric-pressure-difference integration/generation unit, 708 inter-floor atmospheric-pressure-difference output unit, TM, TM1, TM2 atmospheric-pressure trend management unit

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An altitude measurement system comprising:
an altitude measurement terminal connected to the Internet connection; and
data management means connected to the Internet connection,
wherein the altitude measurement terminal includes:
atmospheric-pressure measurement means measuring an atmospheric pressure;
detection means detecting that a moving body exists at a predetermined altitude; and
atmospheric-pressure data output means outputting, when it is detected that the moving body exists at the altitude by the detection means, atmospheric pressure data to the data management means, the atmospheric pressure data being measured during a predetermined period by the atmospheric-pressure measurement means, and
the data management means generates reference atmospheric pressure data corresponding to the altitude by, as needed, calculating an average value among a plurality of pieces of the atmospheric pressure data supplied from the atmospheric-pressure data output means.

2. The altitude measurement system according to claim 1, further comprising
altitude-change detection means detecting altitude change of the moving body by comparing the atmospheric pressure data obtained by measurement by the atmospheric-pressure measurement means with the reference atmospheric pressure data supplied from the data management means.

3. The altitude measurement system according to claim 2,
wherein the altitude measurement terminal further includes:
floor detection means detecting a floor on which the moving body exists; and
current-floor detection means generating information indicating a floor on which the moving body is currently staying, in accordance with information identifying the floor supplied from the floor detection means and information indicating the altitude change supplied from the altitude-change detection means.

4. The altitude measurement system according to claim 2,
wherein the altitude measurement terminal further includes:
floor detection means detecting a floor on which the moving body exists; and
current-floor detection means identifying movement of the moving body from a floor to a floor by comparing previously-obtained inter-floor atmospheric-pressure-difference data serving as a reference with atmospheric pressure data obtained by measurement by the atmospheric-pressure measurement means that is caused by the altitude change detected by the altitude-change detection means, and generating information indicating a floor on which the moving body is currently staying, in accordance with information identifying the floor detected by the floor detection means.

5. The altitude measurement system according to claim 4,
wherein the altitude measurement terminal further includes
offset estimation means estimating an offset value in measurement of the atmospheric pressure by the atmospheric-pressure measurement means in accordance with the information indicating the floor on which the moving body is currently staying that is supplied from the current-floor detection means and the reference atmospheric pressure data in the floor on which the moving body is currently staying that is supplied from the data management means.

6. An altitude measurement system comprising:
an altitude measurement terminal connected to the Internet connection; and
data management means connected to the Internet connection,
wherein the altitude measurement terminal includes:
atmospheric-pressure measurement means measuring an atmospheric pressure;
floor-movement detection means detecting movement of a moving body from a floor to a floor; and
atmospheric-pressure-difference data output means, when the movement of the moving body from the floor to the floor is detected by the floor-movement detection means, outputting data to the data management means, the data indicating atmospheric pressure difference between the floors obtained before and after the movement, and the data being measured by the atmospheric-pressure measurement means, and
the data management means generates reference atmospheric-pressure-difference data corresponding to the movement from the floor to the floor by, as needed, calculating an average value among pieces of data indicating a plurality of the atmospheric-pressure differences supplied from the atmospheric-pressure-difference data output means.

7. The altitude measurement system according to claim 6,
wherein the altitude measurement terminal further includes:
floor detection means detecting a floor on which the moving body exists; and
current-floor detection means identifying the movement of the moving body from
the floor to the floor by comparing the reference atmospheric pressure data supplied from the data management means with the data indicating the atmospheric pressure difference between the floors, the data being obtained by measurement by the atmospheric-pressure measurement means, and generating information indicating a floor on which the moving body is currently staying, in accordance with information identifying the floor detected by the floor detection means.

8. An altitude measurement method measuring an altitude of a moving body by using an altitude measurement terminal connected to the Internet connection and data management means connected to the Internet connection, the method comprising:
a first step of outputting, to the data management means, atmospheric pressure data being measured during a predetermined period by the altitude measurement terminal when it is detected that the moving body exists at a predetermined altitude by the altitude measurement terminal; and
a second step of generating reference atmospheric pressure data corresponding to the altitude by, as needed, calculating an average value among a plurality of pieces of the atmospheric pressure data supplied to the data management means.

9. The altitude measurement method according to claim 8 further comprising
a third step of detecting altitude change of the moving body by comparing the atmospheric pressure data obtained by measurement by the altitude measurement terminal with the reference atmospheric pressure data.

10. The altitude measurement method according to claim 9 further comprising
a fourth step of detecting a floor on which the moving body exists, by the altitude measurement terminal; and
a fifth step of generating information indicating a floor on which the moving body is currently staying, in accordance with information identifying the floor detected in the fourth step and information indicating the altitude change detected in the third step.

11. The altitude measurement method according to claim 9 further comprising
a fourth step of detecting a floor on which the moving body exists, by the altitude measurement terminal;
a fifth step of identifying movement of the moving body from a floor to a floor by comparing previously-obtained inter-floor atmospheric-pressure-difference data serving as a reference with data indicating atmospheric-pressure difference measured in accordance with the altitude change; and
a sixth step of generating information indicating a floor on which the moving body is currently staying, in accordance with information identifying the floor detected in the fourth step and information indicating the movement from the floor to the floor identified in the fifth step.

12. The altitude measurement method according to claim 11 further comprising
a seventh step of estimating an offset value in measurement of the atmospheric pressure in accordance with the information indicating the floor on which the moving body is currently staying, the information being generated in the sixth step, and the reference atmospheric pressure data in the floor on which the moving body is currently staying.

13. An altitude measurement method of measuring an altitude of a moving body by using an altitude measurement terminal connected to the Internet connection and data management means connected to the Internet connection, the method comprising:
a first step of measuring an atmospheric pressure by the altitude measurement terminal;
a second step of detecting movement of a moving body from a floor to a floor;
a third step of, when the movement is detected in the second step, outputting data to the data management means, the data indicating atmospheric pressure difference between the floors before and after the movement, and the data being measured in the first step; and
a fourth step of generating reference atmospheric-pressure-difference data corresponding to the movement from the floor to the floor by, as needed, calculating an average value among pieces of data indicating a plurality of the atmospheric-pressure differences supplied to the data management means.

14. The altitude measurement method according to claim 13 further comprising:
a fifth step of identifying the movement of the moving body from the floor to the floor by comparing the reference atmospheric-pressure-difference data with the data indicating the atmospheric pressure difference between the floors measured by the altitude measurement terminal;
a sixth step of detecting a floor on which the moving body exists by the altitude measurement terminal; and
a seventh step of generating information indicating a floor on which the moving body is currently staying, in accordance with information indicating the movement from the floor to the floor identified in the fifth step and information identifying the floor detected in the sixth step.
